(19) United States
(12) Patent Application Publication
(10) Pub. No.: US 2007/0147542 A1
(43) Pub. Date: Jun. 28, 2007

(54) Method and apparatus for encoding a data stream for transmission across bonded channels

(75) Inventors: Mark S. Schmidt, San Diego, CA (US); Gerald R. Joyce, Newton, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/316,129

(22) Filed: Dec. 22, 2005

(51) Int. Cl. H04L 27/36; H04L 23/02

(52) U.S. Cl. 375/298; 375/265

(57) ABSTRACT

Method and apparatus for encoding a protocol data unit (PDU) stream is described. In one example, packets of the PDU stream are outer coded to produce a symbol stream. The symbol stream is formatting to produce trellis groups. The trellis groups are formed into blocks of M×N groups. For each of the blocks, M groups are processed using N trellis encoders to produce N trellis encoder outputs. Each of the N trellis encoder outputs is mapped onto a quadrature amplitude modulation (QAM) constellation to generate N QAM symbol streams. In another example, a single shared trellis encoder is used and channel bond grouping is performed on the encoded QAM symbols.

### BACKGROUND OF THE INVENTION

1. Field of the Invention

The present invention relates to content delivery systems and, more particularly, to a method and apparatus for encoding a data stream for transmission across bonded channels.

2. Description of the Background Art

The demand for broadband content by business and residential subscribers is continually increasing. Broadband content includes multiple types of communications and data, such as broadcast television channels, video-on-demand, streaming video, multimedia data, Internet access, packet telephony, etc. To meet the increasing demand, it is typically necessary to increase throughput to each subscriber and improve overall quality of service. Current delivery technologies include several variations of digital subscriber line (DSL) technology, which uses telephony facilities, and cable modem systems using cable television facilities and hybrid fiber coaxial (HFC) distribution networks.

Delivery of data services over cable television systems is typically compliant with the Data-over-cable-service-interface-specifications (DOCSIS) standard. The content is typically modulated using quadrature amplitude modulation (QAM). Current cable QAM standards use conventional forward error correction (FEC) techniques to transmit the data downstream. FEC is a system of error control for data transmission where the receiving device has the capability to detect and correct fewer than a predetermined number or fraction of bits or symbols corrupted by transmission errors. FEC is accomplished by adding redundancy to the transmitted information using a predetermined algorithm. The original information may or may not appear in the encoded output; codes that include the un-modified input in the output are systematic, while those that do not are nonsystematic.

To increase capacity, multiple downstream channels are being used to carry a single bitstream using a technique known as “channel bonding.” The input stream is multiplexed across multiple bonded channels at the transmitter and de-multiplexed at the receiver. Present channel bonding techniques used for downstream DOCSIS transmission multiplex data above the link layer by dividing a single protocol data unit (PDU) stream into a plurality of separate PDU streams. Each of the separate PDU streams is then processed for FEC, modulated, and transmitted over a separate bonded channel. That is, the data on each of the bonded channels is separately FEC coded and QAM modulated, which exhibits some latency in the QAM forward channels.

Accordingly, there exists a need in the art for a method and apparatus that multiplexing forward channels across bonded channels with reduced latency.

### SUMMARY OF THE INVENTION

Method and apparatus for encoding a protocol data unit (PDU) stream is described. In one embodiment, packets of the PDU stream are outer coded to produce a symbol stream. The symbol stream is formatted to produce trellis groups. The trellis groups are formed into blocks of M×N groups. For each of the blocks, M groups are processed using N trellis coders to produce N trellis coded outputs. Each of the N trellis encoder outputs is mapped onto a quadrature amplitude modulation (QAM) constellation to generate N QAM symbol streams.

In another embodiment, packets of the PDU stream are outer coded to produce a symbol stream. The symbol stream is formatted to produce trellis groups. The trellis groups are processed using a trellis coder to produce a trellis coded output. The trellis coded output is mapped onto a QAM constellation to generate a QAM symbol stream. the QAM symbol stream is formatted into N sets of QAM symbol groups to produce N QAM symbol streams. The N QAM symbol streams are modulated for transmission across N bonded channels.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of content encoding system in accordance with one or more aspects of the invention;

FIG. 2 is a flow diagram depicting an exemplary embodiment of a method of encoding a PDU stream in accordance with one or more aspects of the invention;

FIG. 3 is a block diagram depicting an exemplary embodiment of a decoder for decoding output of the encoding system of FIG. 1;

FIG. 4 is a block diagram depicting another exemplary embodiment of a content encoding system in accordance with one or more aspects of the invention;

FIG. 5 is a flow diagram depicting an exemplary embodiment of a method for encoding a PDU stream in accordance with one or more aspects of the invention; and

FIG. 6 is a block diagram depicting an exemplary embodiment of a decoder for decoding output of the encoding system of FIG. 4.

To facilitate understanding, identical reference numerals have been used, where possible, to designate identical elements that are common to the figures.

### DETAILED DESCRIPTION OF THE INVENTION

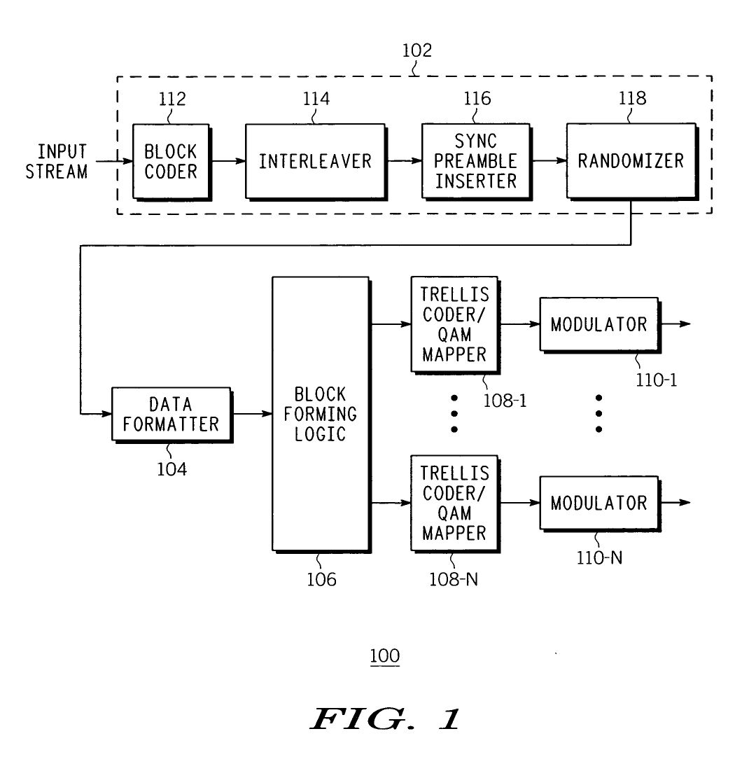

FIG. 1 is a block diagram depicting an exemplary embodiment of content encoding system 100 in accordance with one or more aspects of the invention. The encoding system 100 includes an outer code module 102, a data formatter 104, block forming logic 106, trellis coders/QAM mappers 108-1 through 108-N, and modulators 110-1 through 110-N. The outer code module 102 includes a block coder 112, an interleaver 114, a sync preamble inserter 1 16, and a randomizer 118. The encoding system 100 is configured to process a stream of protocol data units (PDUs) to produce modulated data for downstream transmission over a plurality of bonded channels towards one or more decoders. For example, the encoding system 100 may be used to encode content for downstream transmission over bonded channels towards a modem in a data-over-cable service interface specification (DOCSIS) architecture. The PDU stream may comprise transport stream packets, such as MPEG (moving picture experts group) transport stream packets. It is to be understood that the encoding system 100 may be configured to process other types of PDU streams known in the art.

In particular, an input PDU stream is received by the block coder 112. In one embodiment, the block coder 112 applies a block code to the PDU packets in the input PDU stream. In one embodiment, the outer code module 106 applies a Reed-Solomon (RS) block code. For example, the block coder 112 may apply an (n,k)=(128,122), t=3 symbol-error correcting RS code over Galois Field GF(128) to each PDU packet. That is, the block coder 112 produces 128-symbol blocks having six parity symbols, where each of the symbols is seven bits. Bit errors occurring within three or less symbols of a block at the decoder can be corrected. Details of a (128,122), t=3 RS code are described in the specification of the International Telecommunications Union (ITU) Recommendation J.83 Annex B (referred to as ITU J83.B).

The block coded symbols produced by the block coder 112 are received by the interleaver 114. In one embodiment, the interleaver 114 comprises a, (I,J) convolutional interleaver. As is well known in the art, an (I,J) interleaver sequentially shifts the block coded symbols into a bank of I registers. Each successive register has J symbols more storage than the preceding register. For example, the interleaver 114 may have a depth of I=128. The first interleaver path has zero delay, the second has J symbol period of delay, the third 2*J symbol periods of delay, and so on up to the 128^{th} path, which has 127*J symbol periods of delay. If burst noise in the channel causes a series of bad symbols, they are spread over many symbol blocks (e.g., RS blocks) by a deinterleaver in the decoder such that the resultant symbol errors per block are within the range of the block decoder correction capability. For example, the interleaver 114 may be compliant with ITU J83.B. In particular, a single interleaving depth (128,1) may be used for 64-QAM. For 64-QAM or 256-QAM, the interleaver 114 may employ variable interleaving (e.g., J may be an integer between 1 and 8).

The interleaved symbols output by the interleaver 114 are received by the sync preamble inserter 116. The sync preamble inserter 116 is configured to insert sync preambles for each FEC frame. Each sync preamble comprises a sequence of bits appended to the end of a group of blocks. The sync preamble combined with the group of blocks comprises an FEC frame. For example, in ITU J83.B, an FEC frame for 64-QAM includes a six symbol (42 bit) sync trailer appended to the end of 60 RS blocks, with each block including 128 symbols. An FEC frame for 256-QAM includes a 40-bit sync trailer appended to the end of 88 RS blocks. If the interleaver 114 employs variable interleaving, the type of interleaving is conveyed to the decoder using bits of the sync preamble.

The symbol stream output by the sync preamble inserter 116 is received by the randomizer 118. The randomizer 118 is initialized after each sync preamble and adds a pseudorandom noise (PN) sequence to the data symbols to generate a random sequence. Randomization is not applied to the sync preambles. The randomizer 118 may use a linear feedback shift register specified by a polynomial over GF(128) defined as follows:
f(x)=x³+x+α
Where α is a primitive element of GF(128) such that α⁷+α³+1=0.

The symbol stream output by the randomizer 118 is received by the data formatter 104. The data formatter 104 processes the symbol stream to produce groups of bits referred to herein as “trellis groups”. Each trellis group includes un-coded bits and bits to be encoded. In one embodiment, each trellis group results in generation of five QAM symbols. The number of bits in each trellis group depends on the type of QAM used. In ITU J83.B, for 64-QAM, each trellis group includes 28 bits. Of the 28 bits, there are 20 un-coded bits and 8 bits to be encoded. Each 64-QAM symbol carries four randomized, interleaved, 7-bit RS code symbols. However, the grouping is such that each of the first four QAM symbols in the group carries bits from each of the four 7-bit RS symbols, while the last QAM symbol carries bits from only two of the QAM symbols. Hence, an error to one 64-QAM symbol in the five-symbol trellis group at the demodulator can cause an error in all four RS symbols in the trellis group. For 256-QAM, two different types of trellis groups are defined: a non-sync group and a sync group. The non-sync group includes 38 data bits and the sync group includes 30 data bits and 8 sync bits. Of 38 bits in each trellis group, there are 30 un-coded bits and 8 bits to be encoded. These bits are assigned sequentially to 256-QAM symbols in the trellis group from the serial randomized, interleaved RS codeword stream input. Thus, a given 256-QAM symbol carries bits spanning at most two 7-bit RS symbols. A channel error to one 256-QAM symbol may affect only two such RS symbols. However, note that in both 64-QAM and 256-QAM, the trellis codes are applied to the least-significant bits of the QAM I and Q portions of the symbol mapping; errors occurring in these bits of the QAM symbol can result in propagation of errors beyond a trellis group duration in bit times, due to the maximum likelihood trellis decoding (Viterbi algorithm) often employed in the receiver.

The sequence of trellis groups produced by the data formatter 104 is received by the block forming logic 106. Owing to the bit groupings within trellis groups described above for J83.B, it is advantageous to multiplex the randomizer output into trellis group blocks, as opposed to a finer multiplexing at the bit or QAM symbol level, for input to each of the N trellis encoder and QAM modulator blocks. The block forming logic 106 forms the trellis groups into blocks of M×N groups in preparation for subsequent trellis encoding and QAM mapping, where M is an integer and N corresponds the number N of trellis coders/QAM mappers 108. That is, the block forming logic 106 buffers the input trellis groups until N sets of M trellis groups are collected to form an M×N block of trellis groups. Set 1 includes the first (in time) M trellis groups, set 2 includes the second (in time) M trellis groups, and so on until set N includes the nth (in time) M trellis groups. After an M×N block of trellis groups is collected, the block forming logic 106 provides the N sets of M trellis groups to the N trellis coder/QAM mappers 108-1 through 108-N, respectively. That is, each of the trellis coder/QAM mappers 108 receives a different set of M trellis groups. The process is repeated for each M×N block of trellis groups.

The value M is chosen based on the expected duration of burst noise events on an individual QAM channel given the convolutional interleaver parameters and the known error correction capability of the outer RS code used in J.83B (for example). As is well known in the art, the (I,J) convolutional deinterleaver separates two consecutive input 7-bit RS symbols by IJ-1 RS symbol periods at the deinterleaver output. Similarly, deinterleaver inputs that are separated in time by i symbols will be separated by i(IJ-1) symbols at the deinterleaver output. For a t=3 symbol-error-correcting, length n=128 symbol outer RS code such as in J83.B, three symbol errors occurring in any length n input can be corrected by the RS decoder. By choosing I=n=128, a burst of errored symbols at the deinterleaver input that is shorter than IJt symbols will have less than t=3 errors occurring in any n=128 symbol deinterleaver output word and, hence, will be corrected by the RS decoder (given proper deinterleaver synchronization and no other errors at the interleaver input than those caused by the burst). Other regular symbol error patterns at the deinterleaver input will also result in correctable output codewords, e.g., if every fourth RS symbol was in error at this deinterleaver input over a span of 4IJt symbols. In one embodiment, each trellis encoder/QAM mapper is encoding a sequential block of 28M bits carrying 28M/7=4M RS symbols or 38M bits carrying 38M/7 RS symbols for J83.B 64-QAM or 256-QAM, respectively. Hence, M can be chosen to be about equal the expected channel burst noise protection period covered by the choice of interleaver parameters, i.e., ┌38M/7┐≈IJt.

Each of the trellis coder/QAM mappers 108 is configured to perform trellis coding on each of the M trellis groups. In particular, each of the trellis coder/QAM mappers 108 encodes the bits to be encoded of each trellis group using, for example, a rate 4/5 convolutional coder on the least significant bits of the I and Q portions of the QAM symbol. As such, for each trellis group, the encoded bits are processed together with the un-coded bits to produce 5 QAM symbols. Since there are M trellis groups per M×N block, each of the trellis coder/QAM mappers 108 produces 5M QAM symbols. The trellis coding algorithm is well known in the art and is described in ITU J83.B. In this manner, the trellis coder/QAM mappers 108 produce N QAM symbol streams. The QAM symbols produced by each of the trellis coder/QAM mappers 108-1 through 108-N are received by the modulators 110-1 through 110-N, respectively. The modulators 110 modulate the received QAM symbol streams on radio frequency (RF) carriers in a well known manner. The modulated RF carriers are configured for downstream transmission across N bonded channels.

In this manner, each of the outer code module 102 and the data formatter 104 is shared for each of the N bonded channels. For N bonded channels, the outer code module 102 operates at N times higher bit-rate than a similar outer code module would operate in a non-bonded encoding system. Consider a four channel bonding group (N=4) and a desired burst protection level of 66 microseconds for a J83.B 256-QAM system. For the 256-QAM symbol rate of 5.36 Msps, a burst length of 66 μsec affects (66×10⁻⁶)(5.36×10⁶)≈354 QAM symbols which represents 354/5=70.8 trellis groups each containing 38/7 RS code symbols, i.e., (70.8)(38/7) 384 RS symbols. Assuming only one of the four QAM channels experienced burst noise in any reasonable burst repetition period (e.g., tens of milliseconds), then the interleaver 114 (which is shared among the N bonded channels) need only protect up to 384 RS symbols, i.e., I=128, J=1 interleaving. This would imply a blocking of M˜┌(384×7)/38┐=71 38-bit groups per trellis coder/QAM mapper input. The interleaver/deinterleaver pair would be operating at N=4 times higher rate than non-bonded operation, resulting in a latency of (2.8 milliseconds)/4=0.7 milliseconds. The blocking and buffering of the M=71 38-bit trellis groups would impose an additional delay of 66 microseconds at the transmitter, so the overall delay is 0.766 milliseconds.

In a non-bonded encoder, the interleaver/deinterleaver pair introduces a delay in the transmission system that is given by I(I−1)J RS symbols in duration. For I=128, J=1, this corresponds to 2.8 milliseconds. For I=128, J=8, this corresponds to 22.3 milliseconds. Thus, the encoding system 100 of the invention reduces latency from 2.8 milliseconds for a non-bonded encoder to 0.77 milliseconds for I=128, J=1 interleaving. For I=128, J=8 interleaving, the encoding system 100 reduces latency from 22 milliseconds for a non-bonded encoder to (22 milliseconds)/8+0.5 milliseconds=3.25 milliseconds.

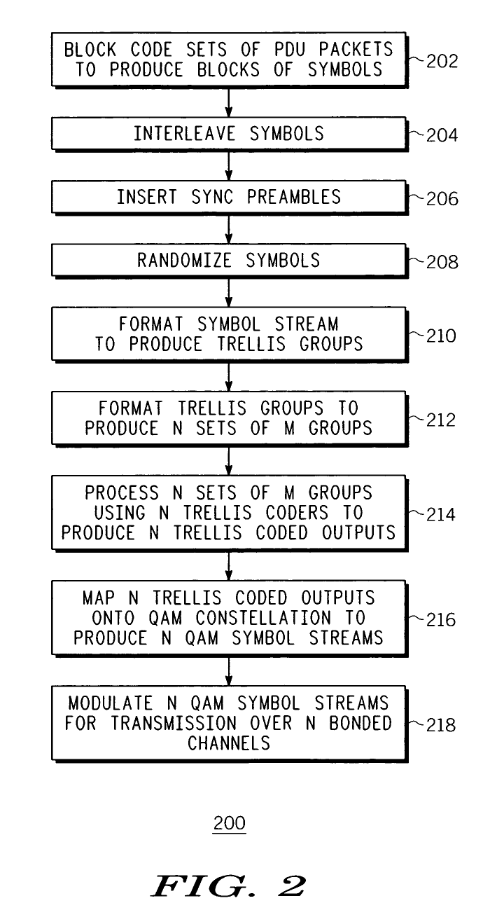

FIG. 2 is a flow diagram depicting an exemplary embodiment of a method 200 of encoding a PDU stream in accordance with one or more aspects of the invention. The method 200 begins at step 202, where sets of packets in the PDU stream are block coded to produce blocks of symbols. At step 204, symbols are interleaved to produce interleaved symbols. At step 206, sync preambles are inserted for each frame of interleaved symbols to generate a symbol stream. At step 208, the symbol stream is randomized. At step 210, the symbol stream is formatted to produce trellis groups. At step 212, the trellis groups are formatted to produce N sets of M trellis groups. At step 214, the N sets of M trellis groups are processed by N trellis coders to produce N trellis coded outputs. At step 216, each of the N trellis coded outputs is mapped onto a QAM constellation to generate N QAM symbol streams. At step 218, the N QAM symbol streams are modulated onto RF carriers and transmitted across N bonded channels. The method 200 is repeated for additional sets of packets in the PDU stream.

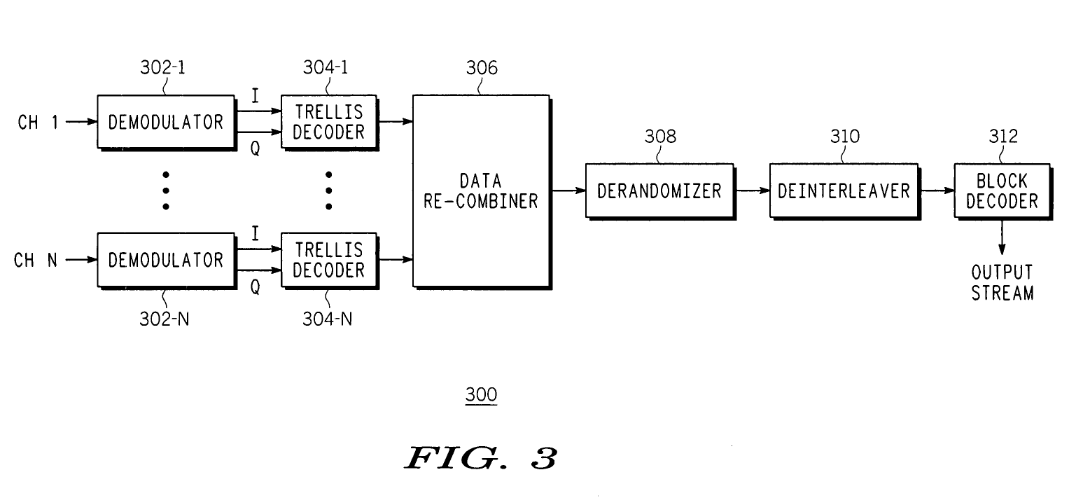

FIG. 3 is a block diagram depicting an exemplary embodiment of a decoder 300 for decoding output of the encoding system 100 of FIG. 1. The decoder 300 comprises demodulators 302-1 through 302-N (collectively referred to as demodulators 302), trellis decoders 304-1 through 304-N (collectively referred to as trellis decoders 304), a data re-combiner 306, a de-randomizer 308, a de-interleaver 310, and a block decoder 312. The demodulators 302 receive the modulated data from the encoding system 100. Each of the demodulators 302 demodulates data from a respective one of the N bonded channels using well-known QAM demodulation techniques to produce in-phase and quadrature (I and Q) values. Each of the demodulators 302 produces one I, Q pair of values per symbol.

The I, Q outputs of the demodulators 302-1 through 302-N are respectively received by the trellis decoders 304-1 through 304-N. Each of the trellis decoders 304 decodes the input I, Q pairs to produce a symbol stream. The N symbol streams produced by the trellis decoders 304 are received by the data re-combiner 306. The data re-combiner 306 is configured to perform the inverse operation of the block forming logic 106. That is, the data re-combiner 306 collects M symbol blocks for each of the N trellis decoders 304 and produces a single output symbol stream. The output symbol stream is received by the de-randomizer 308. The de-randomizer 308 performs the inverse operation of the randomizer 118. The output of the de-randomizer 308 is received by the de-interleaver 310, which performs the inverse operation of the interleaver 114. Output of the de-interleaver 310 is processed by the block decoder 312, which performs the inverse operation of the block coder 112.

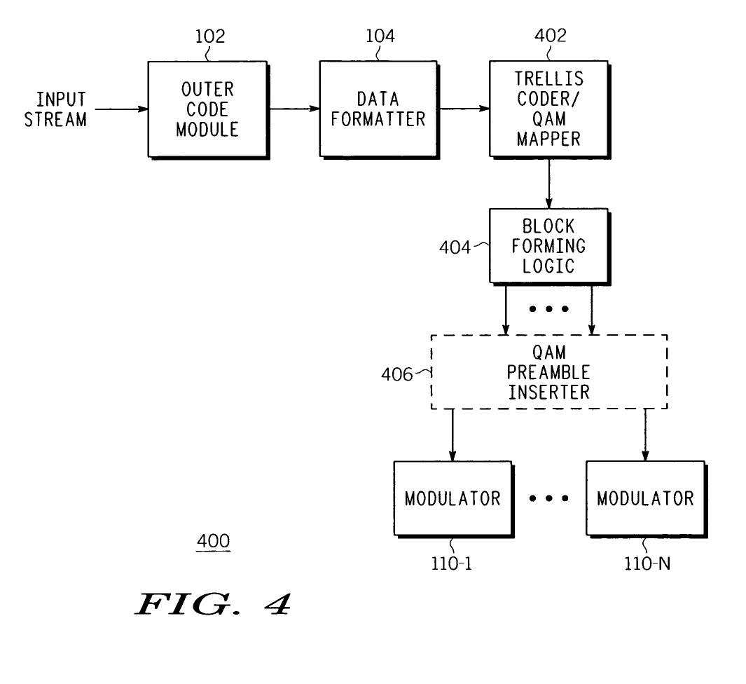

FIG. 4 is a block diagram depicting another exemplary embodiment of a content encoding system 400 in accordance with one or more aspects of the invention. Elements of FIG. 4 that are the same or similar to elements of FIG. 1 are designated with identical reference numerals and described above. In the present embodiment, an input stream is processed by the outer code module 102 and the data formatter 104. The trellis coder/QAM mapper 402 trellis codes each trellis group produced by the data formatter. The trellis coder/QAM mapper 402 encodes the bits to be encoded of each trellis group and processes the encoded bits together with the un-coded bits to produce QAM symbols. In one embodiment, the trellis coder/QAM mapper 402 employs a rate 4/5 convolutional encoder, and produces 5 QAM symbols per trellis group. The QAM symbols produce by the trellis coder/QAM mapper 402 are received by the block forming logic 404. The block forming logic 404 collects N sets of QAM symbols and multiplexes the N sets among N outputs to produce N QAM symbol streams. The N QAM symbol streams are processed by the modulators 110-1 through 110-N for modulation and transmission across N bonded channels.

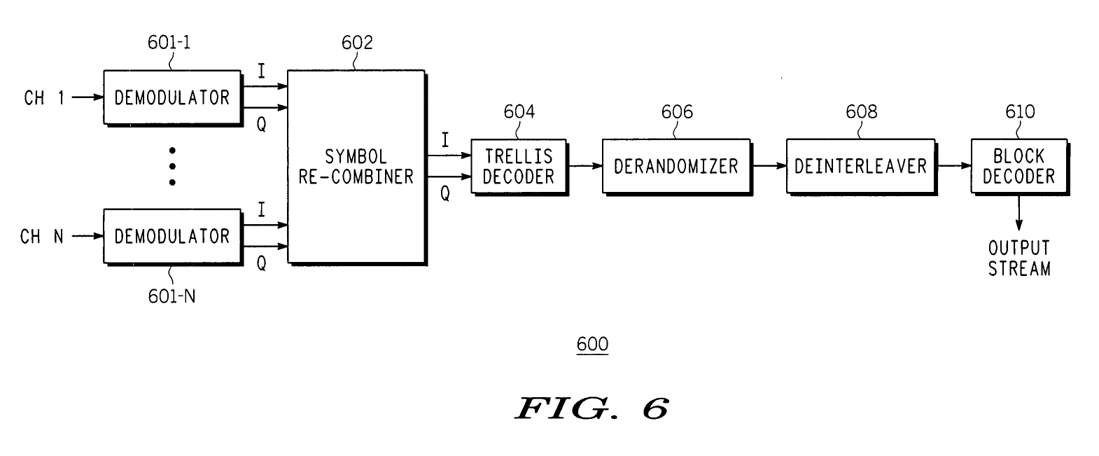

FIG. 6 is block diagram depicting an exemplary embodiment of a decoder 600 for decoding output of the encoding system 400 of FIG. 4. The decoder 600 comprises demodulators 601-1 through 401-N (collectively referred to as demodulators 601), a symbol re-combiner 602, a trellis decoder 604, a de-randomizer 606, a de-interleaver 608, and a block decoder 610. The demodulators 601 receive the modulated data from the encoding system 400. Each of the demodulators 602 demodulates data from a respective one of the N bonded channels using well-known QAM demodulation techniques to produce in-phase and quadrature (I and Q) values. Each of the demodulators 601 produces one I, Q pair of values per symbol.

The I, Q outputs of the demodulators 601-1 through 601-N are respectively received by the symbol re-combiner 602. The symbol re-combiner 602 performs the inverse operation of the block forming logic 404. That is, the symbol re-combiner 602 combines the I, Q pairs from each of the demodulators 601 to produce a single stream of I, Q pairs. The single stream of I, Q pairs is received by the trellis decoder 604. The trellis decoder 604 decodes the input I, Q pairs to produce a symbol stream. The symbol stream produced by the trellis decoder 604 is received by the de-randomizer 606. The de-randomizer 606 performs the inverse operation of the randomizer 118. The output of the de-randomizer 606 is received by the de-interleaver 608, which performs the inverse operation of the interleaver 114. Output of the de-interleaver 608 is processed by the block decoder 610, which performs the inverse operation of the block coder 112.

The encoding system 400 requires alignment of in-phase (I) and quadrature (Q) phase states (0, 90, 180, and 270 degree) in the N QAM demodulators 601 of the bonded channel decoder. If these phase states are not all the same, then the shared trellis decoder 604 would cause errors at channel bonding QAM symbol boundaries as the decoder input would experience bit inversions from QAM symbols demodulated in different phase states and would make errors until the inverted codeword bits were found and restored to the proper phase state. Phase misalignment may be detected by the shared trellis decoder 604 in low noise conditions (e.g., through decoder normalization rate). Alternatively, the encoding system 400 may include a QAM preamble inserter 406. The QAM preamble inserter 406 is configured to insert known QAM symbol-based preambles simultaneously in each of the bonded QAM symbols streams. The demodulators 601 may use the QAM preambles to determine I, Q phase state.

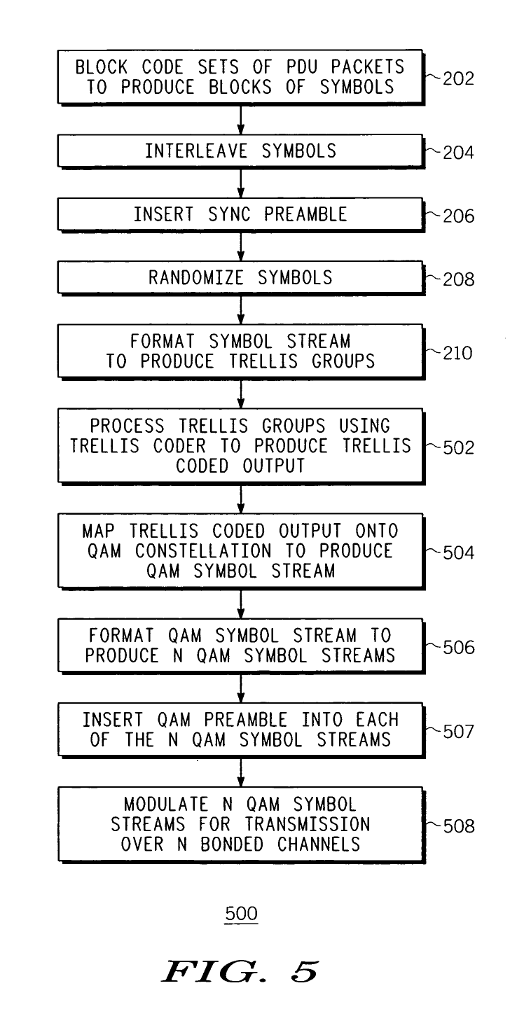

FIG. 5 is a flow diagram depicting an exemplary embodiment of a method 500 for encoding a PDU stream in accordance with one or more aspects of the invention. Steps of FIG. 5 that are the same or similar to steps in FIG. 2 are designated with identical reference numerals and described above. After step 210, the method 500 proceeds to step 502. At step 502, the trellis groups are processed by a trellis coder to produce a trellis coded output. At step 504, the trellis coded output is mapped onto a QAM constellation to produce a QAM symbol stream. At step 506, the QAM symbol stream is formatted to produce N QAM symbol streams. At optional step 507, QAM preambles are inserted into each of the N QAM symbol streams. At step 508, the N QAM symbol streams are modulated for transmission over N bonded channels. The method 500 is repeated for additional sets of packets in the PDU stream.

While the foregoing is directed to illustrative embodiments of the present invention, other and further embodiments of the invention may be devised without departing from the basic scope thereof, and the scope thereof is determined by the claims that follow.

What is claimed is:

1. A method of encoding a protocol data unit (PDU) stream, comprising:
outer coding packets of the PDU stream to produce a symbol stream;
formatting the symbol stream to produce trellis groups;
forming the trellis groups into blocks of M×N groups;
processing, for each of the blocks, M groups using N trellis encoders to produce N trellis encoder outputs; and
mapping each of the N trellis encoder outputs onto a quadrature amplitude modulation (QAM) constellation to generate N QAM symbol streams.

2. The method of claim 1, further comprising:
modulating the N QAM symbols streams onto radio frequency (RF) carriers; and
transmitting the modulated RF carriers across N bonded channels.

3. The method of claim 1, wherein the step of outer coding comprises:
block coding the packets of the PDU stream to block coded symbols;
interleaving the block coded symbols to produce interleaved data; and
randomizing the interleaved data to produce the symbol stream.

4. The method of claim 3, further comprising:
inserting sync preambles in the interleaved data.

5. The method of claim 1, wherein the forming comprises:
sequentially collecting N sets of M groups from the trellis groups to form each of the blocks.

6. Apparatus for encoding a protocol data unit (PDU) stream, comprising:
an outer code module for outer coding packets of the PDU stream to produce a symbol stream;
a data formatter for formatting the symbol stream to produce trellis groups;
block forming logic for forming the trellis groups into blocks of M×N groups; and
N trellis encoders/QAM mappers configured to process, for each of the blocks, M groups to produce N trellis encoder outputs and to map each of the N trellis encoder outputs onto a quadrature amplitude modulation (QAM) constellation to generate N QAM symbol streams.

7. The apparatus of claim 6, further comprising:
N modulators for respectively modulating the N QAM symbols streams onto radio frequency (RF) carriers for transmission across N bonded channels.

8. The apparatus of claim 6, wherein the outer code module comprises:
a block coder for block coding the packets of the PDU stream to block coded symbols;
an interleaver for interleaving the block coded symbols to produce interleaved data; and
a randomizer for randomizing the interleaved data to produce the symbol stream.

9. The apparatus of claim 8, further comprising:
a sync preamble inserter for inserting sync preambles in the interleaved data.

10. The apparatus of claim 6, wherein the block forming logic is configured to sequentially collect N sets of M groups from the trellis groups to form each of the blocks.

11. A method of encoding a protocol data unit (PDU) stream, comprising:
outer coding packets of the PDU stream to produce a symbol stream;
formatting the symbol stream to produce trellis groups;
processing the trellis groups using a trellis encoder to produce a trellis encoder output;
mapping the trellis encoder output onto a quadrature amplitude modulation (QAM) constellation to generate a QAM symbol stream;
formatting the QAM symbol stream into N sets of QAM symbol groups to produce N QAM symbol streams; and
modulating the N QAM symbol streams for transmission across N bonded channels.

12. The method of claim 11, wherein the step of outer coding comprises:
block coding the packets of the PDU stream to block coded symbols;
interleaving the block coded symbols to produce interleaved data; and
randomizing the interleaved data to produce the symbol stream.

13. The method of claim 12, further comprising:
inserting sync preambles in the interleaved data.

14. The method of claim 12, wherein the block coding comprises Reed-Solomon (RS) coding and the interleaving comprises convolutional interleaving.

15. The method of claim 11, further comprising:
inserting QAM preambles into each of the N QAM symbol streams prior to the step of modulating.

16. Apparatus for encoding a protocol data unit (PDU) stream, comprising:
an outer code module outer coding packets of the PDU stream to produce a symbol stream;
a data formatter for formatting the symbol stream to produce trellis groups;
a trellis encoder/QAM mapper for processing the trellis groups to produce a trellis encoder output and mapping the trellis encoder output onto a quadrature amplitude modulation (QAM) constellation to generate a QAM symbol stream;
block forming logic for formatting the QAM symbol stream into N sets of QAM symbol groups to produce N QAM symbol streams; and
N modulators for respectively modulating the N QAM symbol streams for transmission across N bonded channels.

17. The apparatus of claim 16, wherein the outer code module comprises:
a block coder for block coding the packets of the PDU stream to block coded symbols;
an interleaver for interleaving the block coded symbols to produce interleaved data; and
a randomizer for randomizing the interleaved data to produce the symbol stream.

18. The apparatus of claim 17, further comprising:
a sync preamble inserter for inserting sync preambles in the interleaved data.

19. The appartus of claim 17, wherein the block coder comprises a Reed-Solomon (RS) coder and the interleaver comprises convolutional interleaver.

20. The apparatus of claim 11, further comprising:
a QAM preamble inserter for inserting QAM preambles into each of the N QAM symbol streams.
